(19) United States
(12) Patent Application Publication
(10) Pub. No.: US 2013/0177433 A1
(43) Pub. Date: Jul. 11, 2013

(54) MULTI-MATERIAL RETROFITTED WIND TURBINE ROTOR BLADE AND METHODS FOR MAKING THE SAME

(71) Applicants: Peter James Fritz, Walled Lake, MI (US); Jason Joseph Testa, Simpsonville, SC (US); Aaron Alpheus Yarbrough, Clemson, SC (US)

(72) Inventors: Peter James Fritz, Walled Lake, MI (US); Jason Joseph Testa, Simpsonville, SC (US); Aaron Alpheus Yarbrough, Clemson, SC (US)

(73) Assignee: General Electric Company

(21) Appl. No.: 13/348,477

(22) Filed: Jan. 11, 2012

(51) Int. Cl. F03D 1/06; B23P 6/00

(52) U.S. Cl. 416/226; 29/889.1

(57) ABSTRACT

Multi-material retrofitted wind turbine rotor blades include a shell having a leading edge opposite a trailing edge and a structural support member that supports the shell and is disposed internal the wind turbine rotor blade between the leading edge and the trailing edge and extends for at least a portion of a rotor blade span length, wherein the structural support member includes an original structural support portion including a first material and a retrofitted structural support portion extending from the original structural support portion at a joint and including a second material.

### BACKGROUND OF THE INVENTION

The subject matter disclosed herein relates to wind turbine rotor blades and, more specifically, to wind turbine rotor blades retrofitted to have components comprising multiple materials.

Wind power can be considered one of the cleanest, most environmentally friendly energy sources presently available, and wind turbines have gained increased attention in this regard. A wind turbine can include a tower, generator, gearbox, nacelle, and one or more rotor blades comprising a composite material. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

The rotor blades of wind turbines are thus manufactured to maintain a secure connection while maintaining their structural integrity during rotation. The various components may be selected from a variety of materials to provide the requisite strength, stiffness and other necessary characteristics. However, the materials that are capable of providing the requisite structural characteristics around the root of the wind turbine rotor blade may also weigh down or otherwise impede the performance around the tip.

Accordingly, alternative wind turbine rotor blades and methods for making the same would be welcome in the art.

### BRIEF DESCRIPTION OF THE INVENTION

In one embodiment a multi-material retrofitted wind turbine rotor blade is provided. The multi-material retrofitted wind turbine rotor blade includes a shell having a leading edge opposite a trailing edge and a structural support member that supports the shell and is disposed internal the wind turbine rotor blade between the leading edge and the trailing edge and extends for at least a portion of a rotor blade span length. The structural support member includes an original structural support portion including a first material and a retrofitted structural support portion extending from the original structural support portion at a joint and including a second material.

In one embodiment a multi-material retrofitted wind turbine rotor blade is provided. The multi-material retrofitted wind turbine rotor blade includes a shell having a leading edge opposite a trailing edge, and including an original shell portion comprising a first material and a retrofitted shell portion extending from the original shell portion at a joint and comprising a second material. The multi-material retrofitted wind turbine rotor blade further includes a structural support member that supports the shell and is disposed internal the wind turbine rotor blade between the leading edge and the trailing edge and extends for at least a portion of a rotor blade span length.

In yet another embodiment, a method for retrofitting a wind turbine rotor blade is provided. The method includes providing the wind turbine rotor blade that includes a shell having a leading edge opposite a trailing edge, and a structural support member that supports the shell and is disposed internal the wind turbine rotor blade between the leading edge and the trailing edge and extends for at least a portion of a rotor blade span length. The method further includes removing an original outer section from an original portion of the wind turbine rotor blade, wherein the original portion includes a first material, and, attaching a retrofitted portion to the original portion of the wind turbine rotor blade in place of the original outer section, wherein the retrofitted portion includes a second material.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a perspective view of a wind turbine according to one or more embodiments shown or described herein;

FIG. 2 is a perspective view of a multi-material retrofitted wind turbine rotor blade according to one or more embodiments shown or described herein;

FIG. 3 is a cross section view of a multi-material retrofitted wind turbine rotor blade according to one or more embodiments shown or described herein;

FIG. 4 is a cross section view of a joint according to one or more embodiments shown or described herein; and

FIG. 5 is a cross section view of another joint according to one or more embodiments shown or described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Multi-material retrofitted wind turbine rotor blades and methods for making the same are disclosed herein. The multi-material retrofitted wind turbine rotor blades can generally comprise an original portion and a retrofitted portion wherein the retrofitted portion replaces an original outer extension of the original portion. The original portion and the retrofitted portion comprise two different materials so that the original portion can still provide the necessary structural support characteristics required for operation while the retrofitted portion can provide additional benefits unique and not provided by the material of the original portion. Such retrofitting may thereby be used to enhance existing wind turbine rotor blades in a variety of settings. This, in turn, can lead to the more efficient utilization and conservation of energy resources such as by promoting the more efficient production and application of key components of wind turbines to materially enhance the quality of the environment by contributing to the restoration and/or maintenance of the basic life-sustaining natural elements.

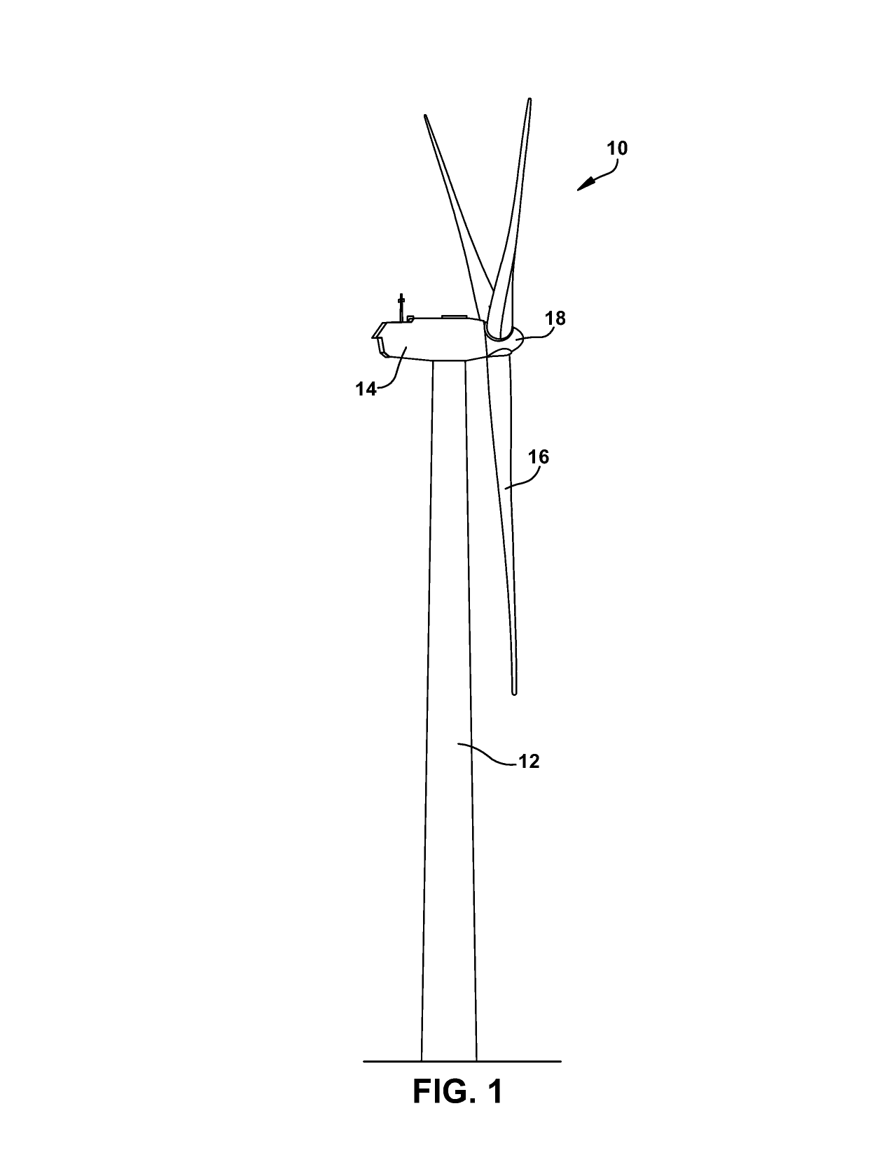

Referring now to FIG. 1, a perspective view of a wind turbine 10 is illustrated. The wind turbine 10 can generally comprise a nacelle 14 mounted on a tower 12. A plurality of multi-material retrofitted wind turbine rotor blades 16 can be mounted to a rotor hub 18 which can be connected to a main flange that turns a main rotor shaft (not illustrated). The wind turbine power generation and control components can be housed within the nacelle 14. It should be appreciated that the wind turbine 10 illustrated in FIG. 1 is provided for illustrative purposes only and not intended to limit the application of this disclosure to a specific wind turbine type or configuration.

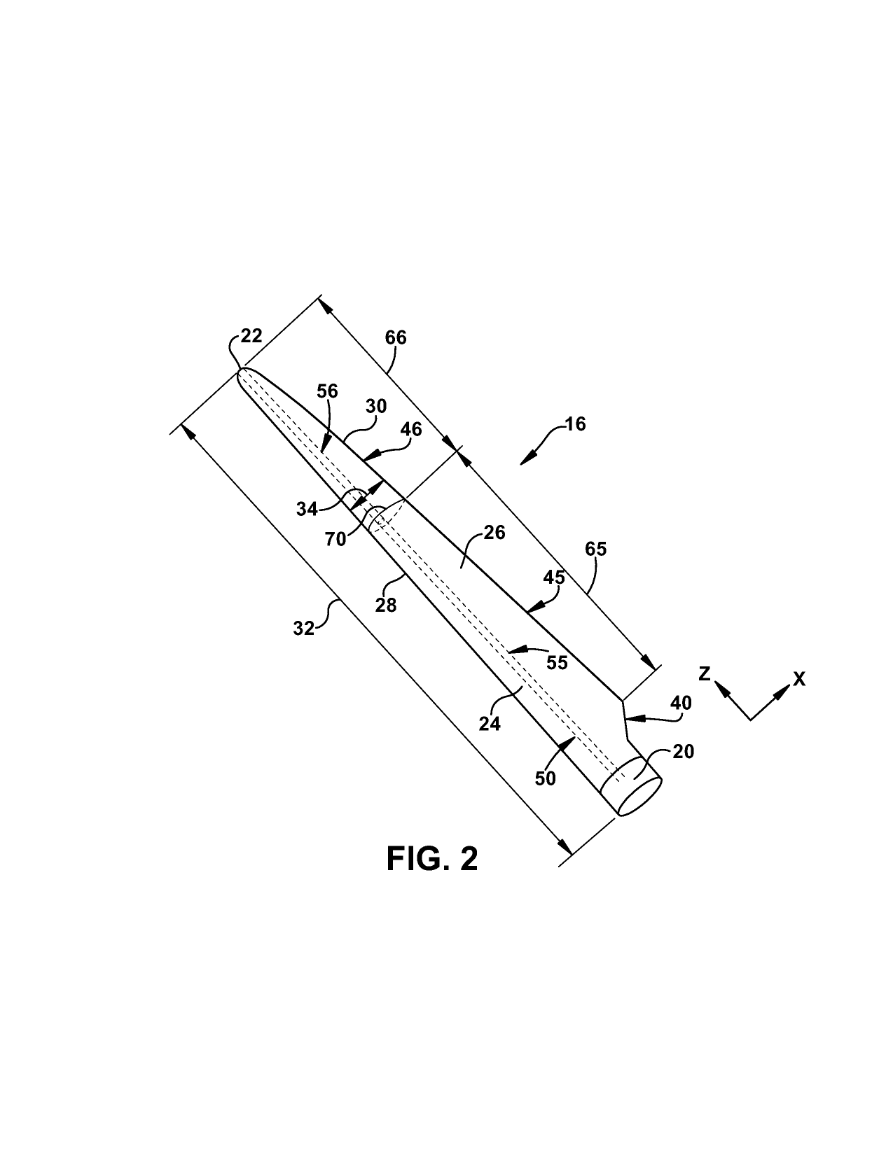

Referring now to FIG. 2, a perspective view of a multi-material retrofitted wind turbine rotor blade 16 is illustrated. The multi-material retrofitted wind turbine rotor blade 16 can include a root 20 for mounting the multi-material retrofitted wind turbine rotor blade 16 to a mounting flange (not illustrated) of the wind turbine hub 18 (illustrated in FIG. 1) and a tip 22 disposed opposite the root 20. The multi-material retrofitted wind turbine rotor blade 16 may comprise a pressure side 24 and a suction side 26 extending between a leading edge 28 and a trailing edge 30. In addition, the multi-material retrofitted wind turbine rotor blade 16 may include a rotor blade span length 32 defining the total length between the root 20 and the tip 22. The multi-material retrofitted wind turbine rotor blade 16 can further comprise a chord 34 defining the total length between the leading edge 28 and the trailing edge 30. It should be appreciated that the chord 34 may vary in length with respect to the rotor blade span length 32 as the multi-material retrofitted wind turbine rotor blade 16 extends from the root 20 to the tip 22.

The multi-material retrofitted wind turbine rotor blade 16 may define any suitable aerodynamic profile. Thus, in some embodiments, the multi-material retrofitted wind turbine rotor blade 16 may define an airfoil shaped cross-section. For example, the multi-material retrofitted wind turbine rotor blade 16 may also be aeroelastically tailored. Aeroelastic tailoring of the multi-material retrofitted wind turbine rotor blade 16 may entail bending the multi-material retrofitted wind turbine rotor blade 16 in generally a chordwise direction x and/or in a generally spanwise direction z. As illustrated, the chordwise direction x generally corresponds to a direction parallel to the chord 34 defined between the leading edge 28 and the trailing edge 30 of the multi-material retrofitted wind turbine rotor blade 16. Additionally, the spanwise direction z generally corresponds to a direction parallel to the rotor blade span length 32 of the multi-material retrofitted wind turbine rotor blade 16. In some embodiments, aeroelastic tailoring of the multi-material retrofitted wind turbine rotor blade 16 may additionally or alternatively comprise twisting the rotor blade 16, such as by twisting the rotor blade 16 about an axis parallel to the z span direction.

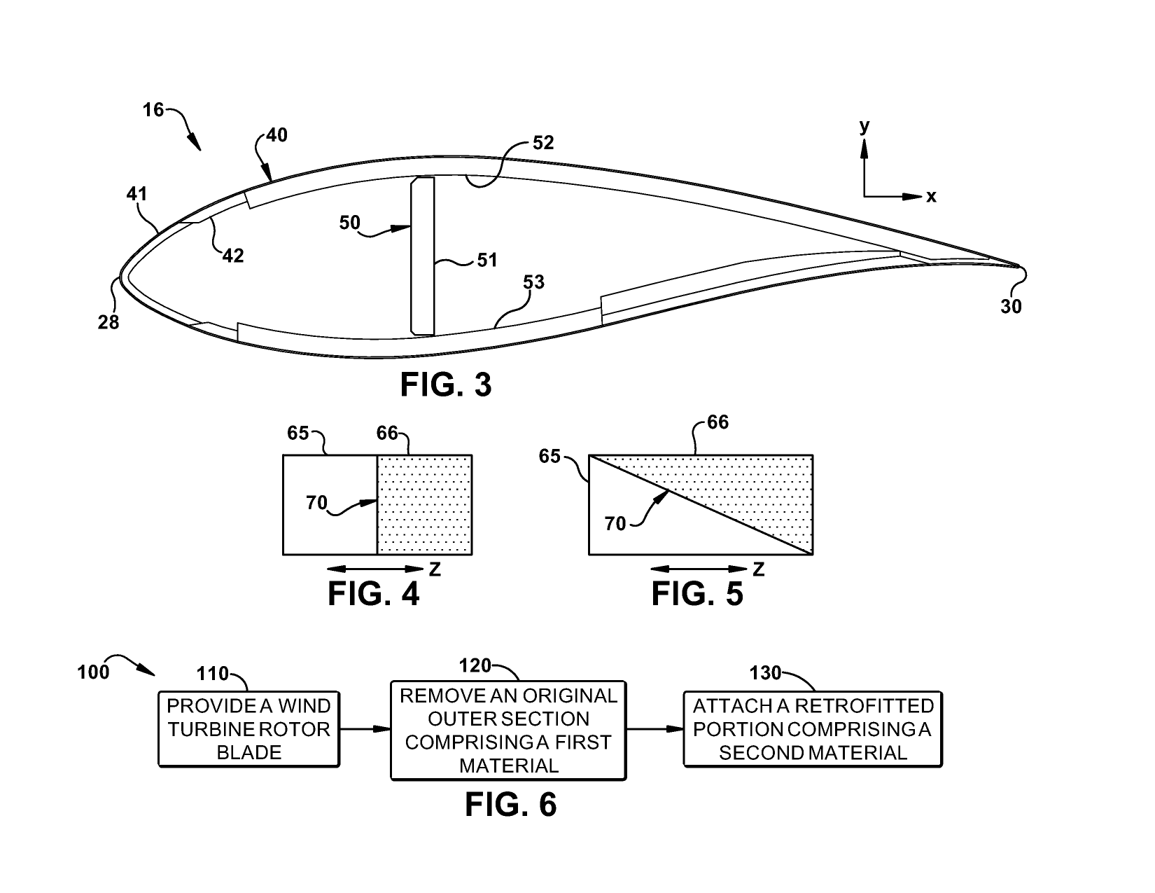

Referring now to FIG. 3, the cross section of the multi-material retrofitted wind turbine rotor blade 16 is illustrated. The structure of the wind turbine rotor blade 16 can generally comprise a shell 40 and a structural support member 50 disposed within the shell 40. As illustrated in FIG. 3, the shell 40 can generally comprise a skin 41 and potentially one or more outer panels 42 supporting the skin. The shell 40 can comprise the leading edge 28 opposite the trailing edge 30 and can comprise materials that allow for the capture of incoming wind for rotating the multi-material retrofitted wind turbine rotor blade 16 while being able to be supported by the structural support member 50. For example, in some embodiments the shell 40 can comprise a composite material. In some embodiments, the shell 40 can comprise a fiberglass material (e.g., a unidirectional fiberglass) or a carbon fiber material (e.g., unidirectional carbon fiber).

In even some embodiments, the shell 40 can comprise a plurality of layers (e.g., a plurality of fiberglass layers) that are connected to one another through adhesives (e.g., glues, tapes, etc.), mechanical fasteners (e.g., screws, bolts, etc.) or the like. In some embodiments, the shell 40 can comprise a plurality of layers held together by an adhesive. While specific embodiments of multi-material retrofitted wind turbine rotor blades 16 have been disclosed herein, it should be appreciated that these embodiments are not intended to be limiting and alternative wind turbine rotor blades 16 (e.g., using additional and/or alternative materials, designs or the like) should also be appreciated.

Referring to FIGS. 2 and 3, the structural support member 50 may be disposed within the shell 40 between the leading edge 28 and the trailing edge 30 and extend for at least a portion of the rotor blade span length 32. The structural support member 50 can comprise any supportive member that is directly or indirectly connected to and supporting the shell 40.

For example, as illustrated in FIG. 3, in some embodiments the structural support member 50 can comprise a shear web 51 and one or more spar caps such as an upper spar caps 52 and a lower spar caps 53. The shear web 51, the upper spar caps 52 and the lower spar caps 53 may extend for any length of the rotor blade span length 32 sufficient to support the overall multi-material retrofitted wind turbine rotor blade 16. For example, in some embodiments the shear web 51, the upper spar caps 52 and the lower spar caps 53 may extend substantially the entire length of the rotor blade span length 32 from the root 20 to the tip 22. In some embodiments, the shear web 51, the upper spar caps 52 and the lower spar caps 53 may only extend for a portion of the rotor blade span length 32. In even some embodiments, the shear web 51, the upper spar cap 52 and the lower spar cap 53 may extend for different lengths independent of one another such as when the upper spar cap 52 and the lower spar cap 53 extend for a length beyond the shear web 51 towards the tip 22. Moreover, while embodiments comprising the shear web 51, the upper spar cap 52 and the lower spar cap 53 have been presented herein, it should be appreciated that other embodiments may also be provided for structural support members such as comprising only one of these elements and/or comprising additional elements not already described herein.

Referring still to FIGS. 2 and 3, the retrofitted wind turbine rotor blade 16 generally comprises an original portion 65 comprising a first material and a retrofitted portion 66 comprising a second material that is different than the first material. The original portion 65 can comprise the original components of the original wind turbine rotor blade and comprise the portion closest to the root 20. Likewise, the retrofitted portion 66 can comprise a new component that replaces an original outer section (not shown) that was removed from the original portion 65 and comprise the portion closest to the tip 22. The original portion 65 and the retrofitted portion 66 can thereby meet at a joint 70; i.e., the point in which the first material meets the second material. The original portion 65 and the retrofitted portion 66 can comprise a variety of different corresponding components of the multi-material retrofitted wind turbine rotor blade 16 and comprise a variety of different material combinations to change the overall structural characteristics. For example, the second material (of the retrofitted portion 66) can comprise a material more suitable for lightning protection, erosion, fouling protection, sound attenuation, or any other desired characteristic compared to the first material (of the original portion 65). This combination of original and retrofitted materials may thereby allow the multi-material retrofitted wind turbine rotor blade 16 to possess the necessary structural requirements proximate its root 20 while incorporating other beneficial material properties proximate its tip 22.

Referring to FIG. 2, in some embodiments the structural support member 50 can comprise an original structural support portion 55 and a retrofitted structural support portion 56. The retrofitted structural support portion 56 can extend from the original structural support portion 55 and replace a previously removed original structural support outer section (not shown) of the original structural support portion 55. In such an embodiment, the original structural support portion 55 (i.e., the portion closest to the root 20) can comprise a first material and the retrofitted structural support portion 56 (i.e., the portion closest to the tip 22) can comprise a second material different than the first material. In some embodiments, the second material may be lighter than the first material such that the multi-material retrofitted wind turbine rotor blade 16 is lighter towards its tip end 22. In some embodiments, the second material may alternatively or additionally be stiffer than the first material such that the multi-material retrofitted wind turbine rotor blade 16 is stiffer towards its tip end 22. Such embodiments may thereby potentially allow for improved aerodynamics (e.g., a longer tip) and/or reduced noise of the multi-material retrofitted wind turbine rotor blade 16 and also help ensure tower clearance as the retrofitted wind turbine rotor blade 16 rotates past the tower 12 (illustrated in FIG. 1). Depending on the construction of the multi-material retrofitted wind turbine rotor blade 16, the components of the structural support portion 50 comprising the first material and the second material can comprise the shear web 51, the upper spar cap 52, the lower spar cap 53 or combinations thereof.

For example, in one exemplary embodiment, the original structural support portion 55 (and the removed original structural support outer section) can comprise fiberglass providing a heavier but more flexible portion towards the root 20. Conversely, the retrofitted structural support portion 56 can comprise carbon fiber to provide a lighter but stiffer portion towards the tip 22.

Referring to FIG. 2, in some embodiments the shell 40 can comprise an original shell portion 45 and a retrofitted shell portion 46. The retrofitted shell portion 46 can extend from the original shell portion 45 and replace a previously removed original shell outer section (not shown) of the original shell portion 45. In such an embodiment, the original shell portion 45 (i.e., the portion closest to the root 20) can comprise a first material and the retrofitted shell portion 46 (i.e., the portion closest to the tip 22) can comprise a second material different than the first material. In some embodiments, the second material may be lighter than the first material such that the multi-material retrofitted wind turbine rotor blade 16 is lighter towards its tip end 22. In some embodiments, the second material may alternatively or additionally be stiffer than the first material such that the multi-material retrofitted wind turbine rotor blade 16 is stiffer towards its tip end 22. Such embodiments may thereby potentially allow for improved aerodynamics and/or reduced noise of the multi-material retrofitted wind turbine rotor blade 16 and also help ensure tower clearance as the retrofitted wind turbine rotor blade 16 rotates past the tower 12 (illustrated in FIG. 1). Depending on the construction of the multi-material retrofitted wind turbine rotor blade 16, the components of the shell portion 40 comprising the first material and the second material can comprise the skin 41, the outer panel 42 or combinations thereof (such as depicted in FIG. 3).

For example, in one exemplary embodiment, the original shell portion 45 (and the removed original shell outer section) can comprise fiberglass providing a heavier but more flexible portion towards the root 20. Conversely, the retrofitted shell portion 46 can comprise carbon fiber to provide a lighter but stiffer portion towards the tip 22. Such embodiments may be realized when the skin 41 comprises the original shell portion 45 and the retrofitted shell portion 46. In another exemplary embodiment, the original shell portion 45 (and the removed original shell outer section) can comprise foam. Conversely, the retrofitted shell portion 46 can comprise balsa wood to provide a lighter but stiffer portion towards the tip 22. Such embodiments may be realized when the outer panel 42 (supporting the skin 41) comprises the original shell portion 45 and the retrofitted shell portion 46.

As discussed above, the retrofitted portion 66 extends from the original portion 65 at the joint 70. The joint 70 can be disposed at any position along the rotor blade span length 32 to provide any relative lengths of the original portion 65 and the retrofitted portion 66. For example, in some embodiments the original portion 65 may comprise up to and including about 98% of the rotor blade span length 32 (such that the retrofitted portion 66 comprises the final 2% of the rotor blade span length 32 approaching the tip 22). In some embodiments, the original portion 65 may comprise up to and including about 50% of the rotor blade span length 32. In even some embodiments, the original portion 65 may comprise up to and including only about 25% of the rotor blade span length 32. While specific positions of the joint 70 have been disclosed herein, it should be appreciated that these are exemplary only and any other position may also be realized.

Referring now to FIGS. 1, 4 and 5, the joint 70 separating the original portion 65 from the retrofitted portion 66 may comprise a variety of configurations. For example, in some embodiments, the joint 70 may comprise a relatively flat interface (as illustrated in FIG. 4). In some embodiments, such as that illustrated in FIG. 5, the joint 70 may comprise a tapered interface 70 that transitions in the ratio of first material (of the original portion 65) to second material (of the retrofitted portion 66) along the spanwise direction z (i.e., the direction of the rotor blade span length 32). Moreover, the original portion 65 may be secured to the retrofitted portion 66 at the joint 70 by any suitable means such as adhesives (e.g., glues, resins, etc.), mechanical fasteners (e.g., bolts, screws, etc.), or any other suitable mechanism, or combinations thereof

Referring now to FIG. 6, a method 100 for retrofitting a wind turbine rotor blade is illustrated. The method 100 generally comprises first providing a wind turbine rotor blade in step 110. The wind turbine rotor blade can be provided in a variety of locations such as in an original manufacturing factory, in the field where it is deployed, or in a repair facility.

Once the wind turbine rotor blade is provided in step 110, an original outer section is removed in step 120. Referring also to FIGS. 2 and 3, as discussed above, the original outer section can comprise a first material along with the remaining original portion (illustrated as element 65 in FIG. 2). The original outer section removed in step 120 can comprise a variety of components such as one or more components of the structural support member 50 (e.g., the shear web 51, the upper spar cap 52 and/or the lower spar cap 53), one or more components of the shell 40 (e.g., the skin 41 and/or one or more outer panels 42), or other component of the wind turbine rotor blade. Moreover, the original outer section may be removed by any suitable means such as by using a saw, laser, or other suitable separating device, or combinations thereof

After the original outer section is removed in step 120, a retrofitted portion is attached in step 130. Referring also to FIGS. 2 and 3, as discussed above, the retrofitted portion 66 can comprise a second material different than the first material. For example, the second material may be selected as a lighter and/or stiffer material compared to the first material, or may be selected as a material more suitable for lightning protection, erosion, fouling protection, sound attenuation, or any other desired characteristic. Moreover, the retrofitted portion 66 may be attached to the original portion 65 at the joint 70 using any suitable means such as adhesives (e.g., glues, tapes, etc.), mechanical fasteners (e.g., screws, bolts, etc.) or the like.

It should now be appreciated that wind turbine rotor blades may be retrofitted to incorporate a new, second material proximate the tip that is different than a first material proximate its root. By maintaining the existing first material proximate the wind turbine rotor blade's root, the wind turbine rotor blade can maintain the structural properties necessary for operation. However, by removing an original outer section and replacing it with a retrofitted portion comprising a second material, the second material can possess additional properties that can be incorporated into the wind turbine rotor blade to further enhance its performance. A variety of different components and combinations of materials may thus be realized to produce the multi-material retrofitted wind turbine rotor blade.

While the disclosure has been described in detail in connection with certain specific embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A multi-material retrofitted wind turbine rotor blade comprising:
a shell comprising a leading edge opposite a trailing edge; and
a structural support member that supports the shell and is disposed internal the wind turbine rotor blade between the leading edge and the trailing edge and extends for at least a portion of a rotor blade span length, the structural support member comprising:
an original structural support portion comprising a first material; and,
a retrofitted structural support portion extending from the original structural support portion at a joint and comprising a second material.

2. The multi-material retrofitted wind turbine rotor blade of claim 1, wherein the structural support member comprises a shear web disposed between an upper spar cap and a lower spar cap.

3. The multi-material retrofitted wind turbine rotor blade of claim 2, wherein the shear web comprises the original structural support portion and the retrofitted structural support portion.

4. The multi-material retrofitted wind turbine rotor blade of claim 2, wherein the upper spar cap or lower spar cap comprises the original structural support portion and the retrofitted structural support portion.

5. The multi-material retrofitted wind turbine rotor blade of claim 1, wherein the second material is lighter than the first material.

6. The multi-material retrofitted wind turbine rotor blade of claim 1, wherein the first material comprises fiberglass.

7. The multi-material retrofitted wind turbine rotor blade of claim 6, wherein the second material comprises carbon fiber.

8. The multi-material retrofitted wind turbine rotor blade of claim 1, wherein the retrofitted structural support portion replaced an original structural support outer section of the original structural support portion.

9. A multi-material retrofitted wind turbine rotor blade comprising:
a shell comprising a leading edge opposite a trailing edge, the shell comprising:
an original shell portion comprising a first material; and,
a retrofitted shell portion extending from the original shell portion at a joint and comprising a second material; and,
a structural support member that supports the shell and is disposed internal the wind turbine rotor blade between the leading edge and the trailing edge and extends for at least a portion of a rotor blade span length.

10. The multi-material retrofitted wind turbine rotor blade of claim 9, wherein the second material is lighter than the first material.

11. The multi-material retrofitted wind turbine rotor blade of claim 9, wherein the shell comprises a skin at least partially supported by an outer panel.

12. The multi-material retrofitted wind turbine rotor blade of claim 11, wherein the outer panel comprises the original structural support portion and the retrofitted structural support portion.

13. The multi-material retrofitted wind turbine rotor blade of claim 12, wherein the first material comprises foam and the second material comprises balsa wood.

14. The multi-material retrofitted wind turbine rotor blade of claim 11, wherein the skin comprises the original structural support portion and the retrofitted structural support portion.

15. The multi-material retrofitted wind turbine rotor blade of claim 14, wherein the first material comprises fiberglass and the second material comprises carbon fiber.

16. The multi-material retrofitted wind turbine rotor blade of claim 9, wherein the retrofitted shell portion replaced an original shell outer section of the original shell portion.

17. A method for retrofitting a wind turbine rotor blade, the method comprising:
providing the wind turbine rotor blade comprising:
a shell comprising a leading edge opposite a trailing edge; and
a structural support member that supports the shell and is disposed internal the wind turbine rotor blade between the leading edge and the trailing edge and extends for at least a portion of a rotor blade span length;
removing an original outer section from an original portion of the wind turbine rotor blade, wherein the original portion comprises a first material; and,
attaching a retrofitted portion to the original portion of the wind turbine rotor blade in place of the original outer section, wherein the retrofitted portion comprises a second material.

18. The method of claim 17, wherein the shell comprises the original portion and the retrofitted portion.

19. The method of claim 17, wherein the structural support member comprises the original outer section and the retrofitted portion.

20. The method of claim 17, wherein the second material is lighter than the first material.
